(19) United States
(12) Patent Application Publication
(10) Pub. No.: US 2026/0225752 A1
(43) Pub. Date: Aug. 6, 2026

(54) METHOD OF MAKING A PACKAGE FOR ACCESSORIES

(71) Applicant: ARACHNE, LLC, Harrison, NY (US)

(72) Inventor: Sophia Wojczak, Harrison, NY (US)

(73) Assignee: ARACHNE, LLC, Harrison, NY (US)

(21) Appl. No.: 19/047,400

(22) Filed: Feb. 6, 2025

(51) Int. Cl. B65B 43/08; B29C 65/00; B29L 31/00; B65D 75/26; B65D 75/28

(52) U.S. Cl. CPC B65B 43/08; B29C 66/4344; B65D 75/26; B65D 75/28; B29L 2031/7128

(57) ABSTRACT

A package and a method of making a package are disclosed. The package is formed from a first sheet attached to a second sheet having upper portions thereof unattached to one another. The package is closed by a closure mechanism adjacent an upper portion thereof. After attaching the first sheet to the second sheet, the package is filled and the upper portion thereof is closed.

The present disclosure relates to a method of making a package, pouch, or container from one or more sheets of material that are heat sealed together.

### TECHNICAL FIELD

Packages made from sheets of plastic that are attached to one another are known. A package having more than one gusset panel and a zipper is known. See JP 4377250. A reclosable rectangular bag with a linear fastener is known. See EP 1 132 312. U.S. Pat. No. 5,938,337 discloses a gusseted bag with a top zipper, where portions of the material are folded.

Improvements in packaging having more than one sheet of material attached together, and methods of making such packages are desired.

### SUMMARY

In a first aspect, a method of making a package comprises providing a first sheet in a circular or semi-circular shape, the first sheet having an upper portion, a lower portion, and side portions, and providing a second sheet in a circular or semi-circular shape, the second sheet having an upper portion, a lower portion, and side portions. The method further comprises attaching the side portions of the first sheet to the side portions of the second sheet, and attaching a third sheet to the lower portion of the first sheet and attaching the third sheet to the lower portion of the second sheet. The method further comprises filling an interior of the package with a product, and closing the package at the upper portion of the first sheet and the upper portion of the second sheet.

The third sheet can have a first side and a second side, wherein the first side is attached to the first sheet and the second side is attached to the second sheet.

The first sheet can have a first portion of a closure mechanism and the second sheet can have a second portion of a closure mechanism. In embodiments, the package is closed by engaging the first portion of the closure mechanism with the second portion of the closure mechanism.

In embodiments, the upper portion of the first sheet and the upper portion of the second sheet are not attached to one another.

The first sheet, second sheet, and third sheet can be sheets of a thermoplastic polymer. For example, at least one of the first sheet, second sheet, and third sheet can be sheets of polymer having a foil included therein.

In embodiments, at least the third sheet is a sheet of material different from the sheet of material of the first sheet.

The first sheet, second sheet, and third sheet can be attached by heat sealing.

The closure mechanism can be selected from a press seal, a zipper, one or more buttons, an adhesive, and a set of hook and loop fasteners.

The package can be filled with the product from an upper portion of the package, for example, and the package can be filled with the product from a lower portion of the package.

In another aspect, a package comprises a first sheet having an upper portion, a lower portion, and side portions, a second sheet having an upper portion, a lower portion, and side portions, the side portions of the first sheet being attached to the side portions of the second sheet, and a third sheet attached to the first sheet at the lower portion of the first sheet, the third sheet being attached to the second sheet at the lower portion of the second sheet. A first part of a closure mechanism is adjacent the upper portion of the first sheet, and a second part of a closure mechanism is adjacent the upper portion of the second sheet, the package being closable by engaging the first part of the closure mechanism with the second part of the closure mechanism, the upper portion of the first sheet being unattached to the upper portion of the second sheet.

In embodiments, the third sheet has a first side attached to the first sheet and a second side attached to the second sheet.

The first sheet, second sheet, and third sheet can be sheets of thermoplastic polymer. In embodiments, at least one of the first sheet, second sheet, and third sheet have a foil material incorporated therein.

The first sheet and second sheet have a circular or semi-circular shape, in certain embodiments.

The closure mechanism can be selected from a group consisting of a zipper, a press seal, a series of buttons, and a set of hook and loop fasteners.

At least one of the first sheet, second sheet, and third sheet can have a material that is different from a material of the other of the first sheet, second sheet, and third sheet.

In embodiments, the third sheet has a first narrow end, a second narrow end, and a middle portion that is broader than the first narrow end and the second narrow end.

### BRIEF DESCRIPTION OF THE DRAWINGS

In order that the disclosure may be readily understood, aspects of the apparatus are illustrated by way of examples in the accompanying drawings, in which like parts are referred to with like reference numerals throughout.

FIG. 1 is a top front right side perspective view of the package according to embodiments of the present disclosure, shown having a product disposed therein;

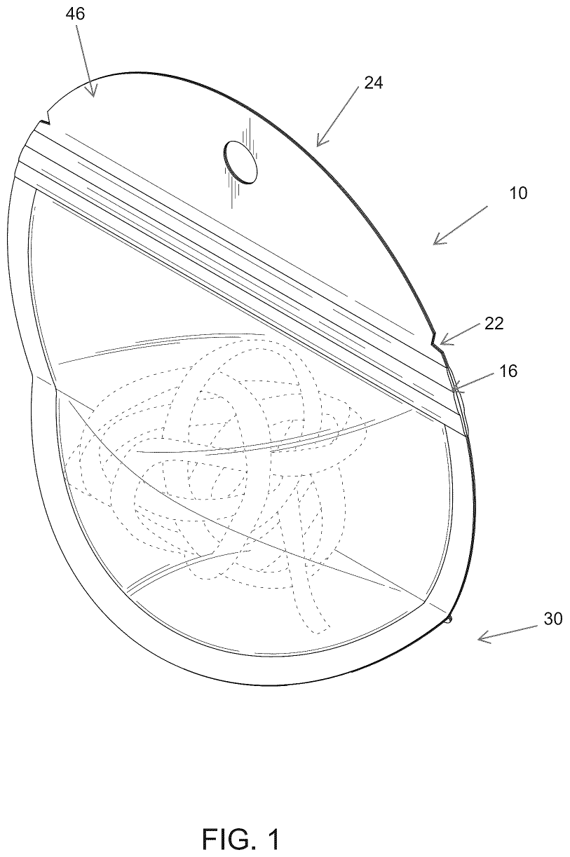

FIG. 2 is a top front right side perspective view, according to the embodiment of FIG. 1;

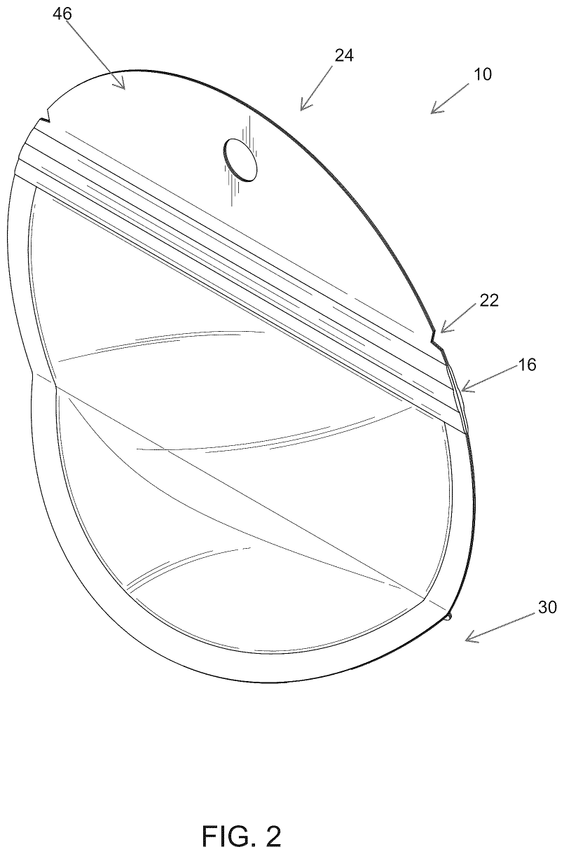

FIG. 3 is a bottom rear left side perspective view, according to the embodiment of FIGS. 1-2;

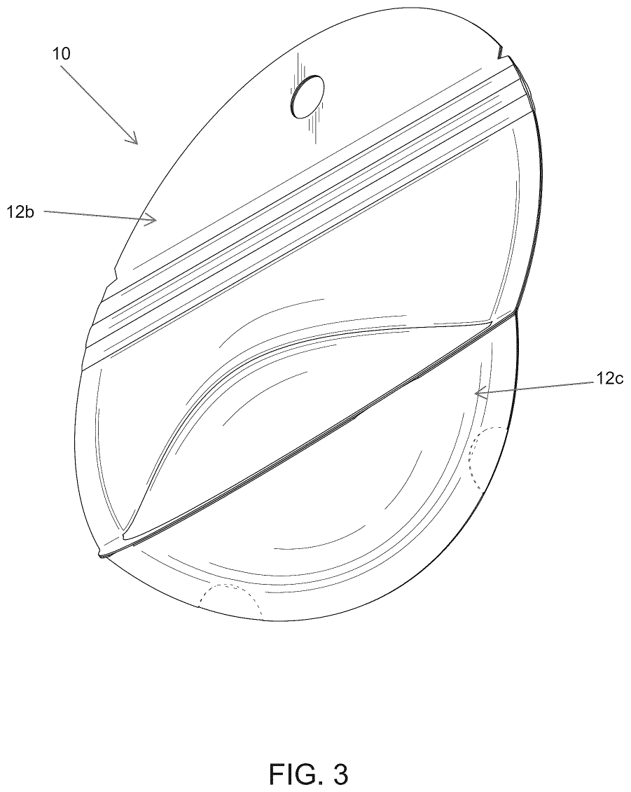

FIG. 4 is a front elevational view, according to the embodiment of FIGS. 1-3;

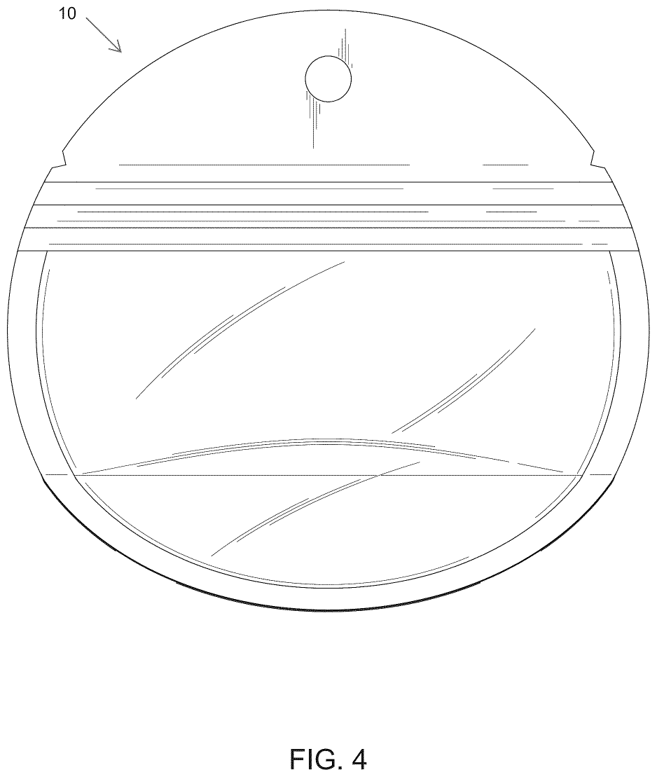

FIG. 5 is a rear elevational view, according to the embodiment of FIGS. 1-4;

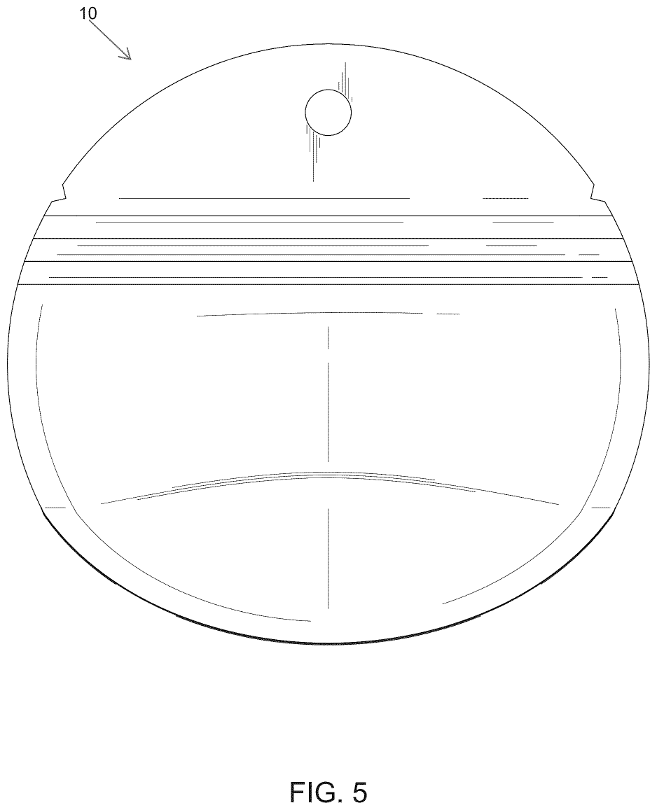

FIG. 6 is a left side elevational view, according to the embodiment of FIGS. 1-5;

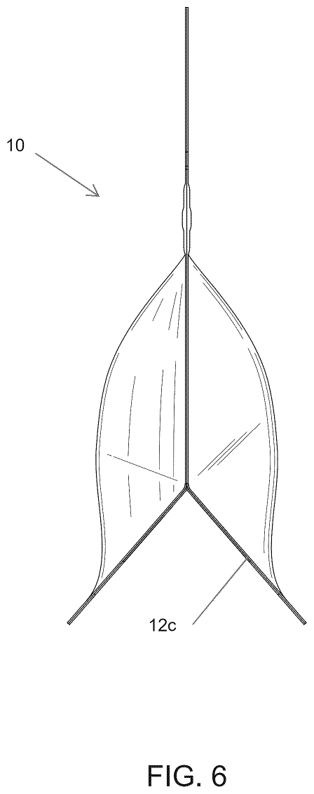

FIG. 7 is a right side elevational view, according to the embodiment of FIGS. 1-6;

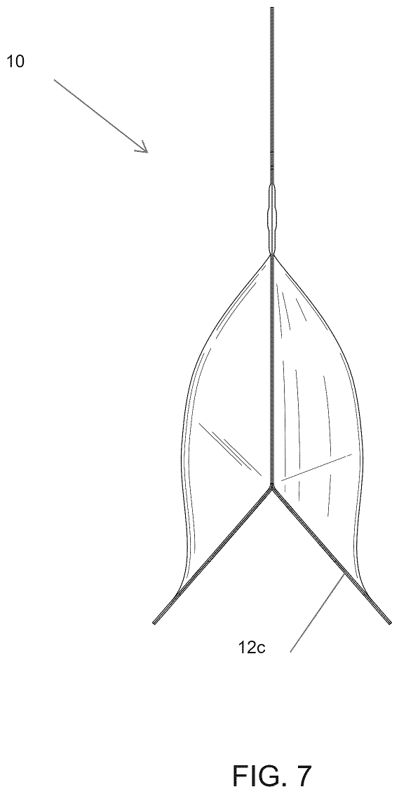

FIG. 8 is a top plan view, according to the embodiment of FIGS. 1-7;

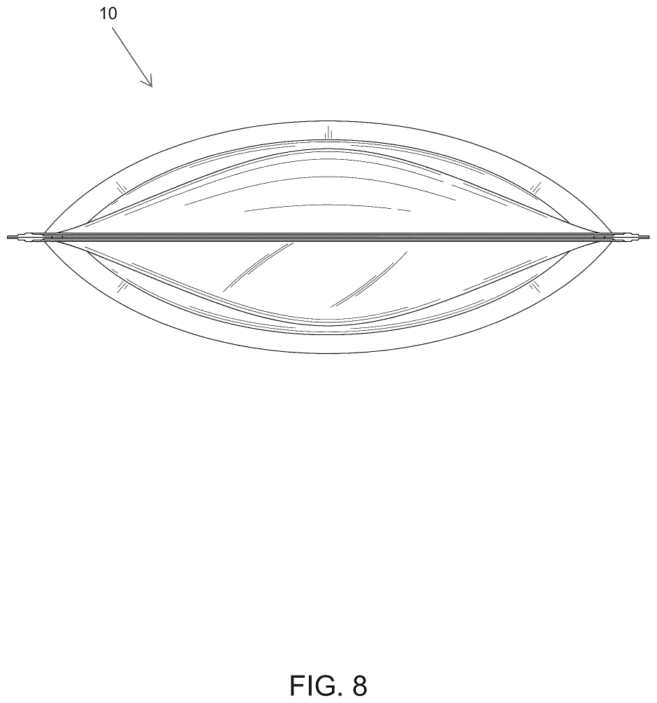

FIG. 9 is a bottom plan view, according to the embodiment of FIGS. 1-8;

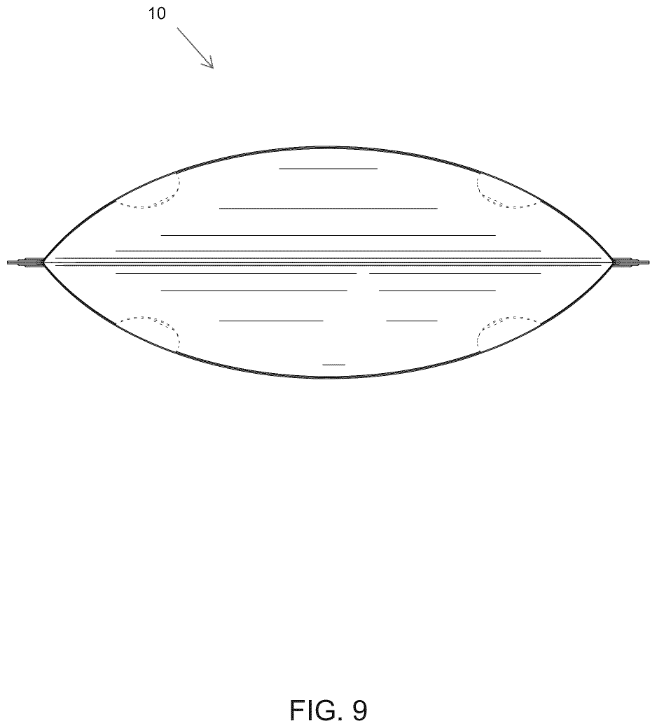

FIG. 10 is a top front right side perspective view of the package, according to a further embodiment;

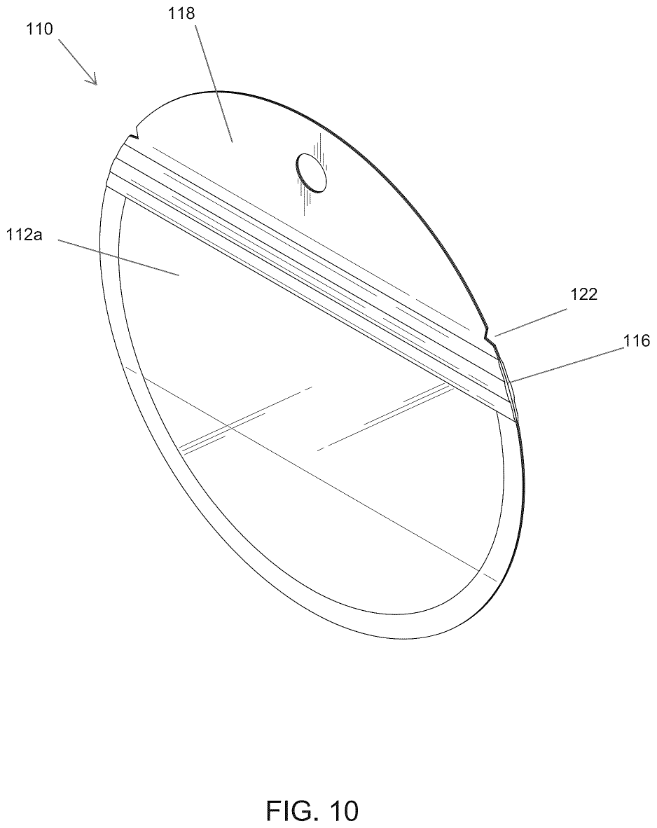

FIG. 11 is a bottom rear left side perspective view, according to the embodiment of FIG. 10;

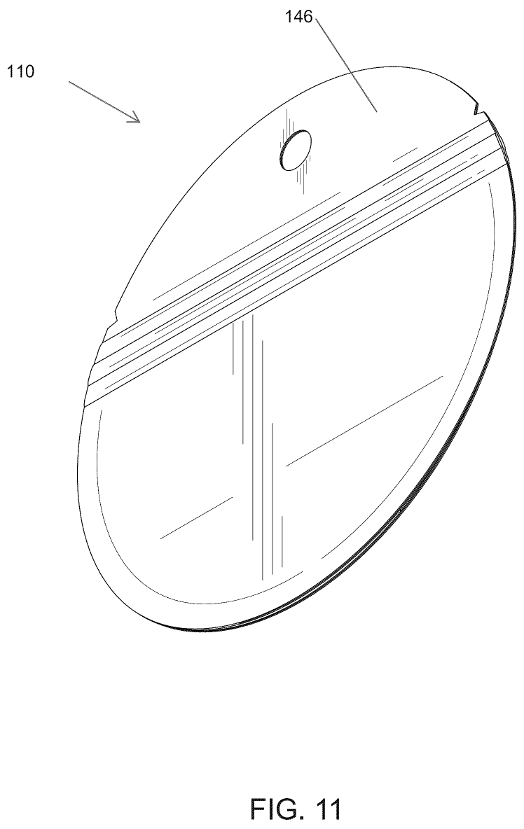

FIG. 12 is a front elevational view, according to the embodiment of FIGS. 10-11;

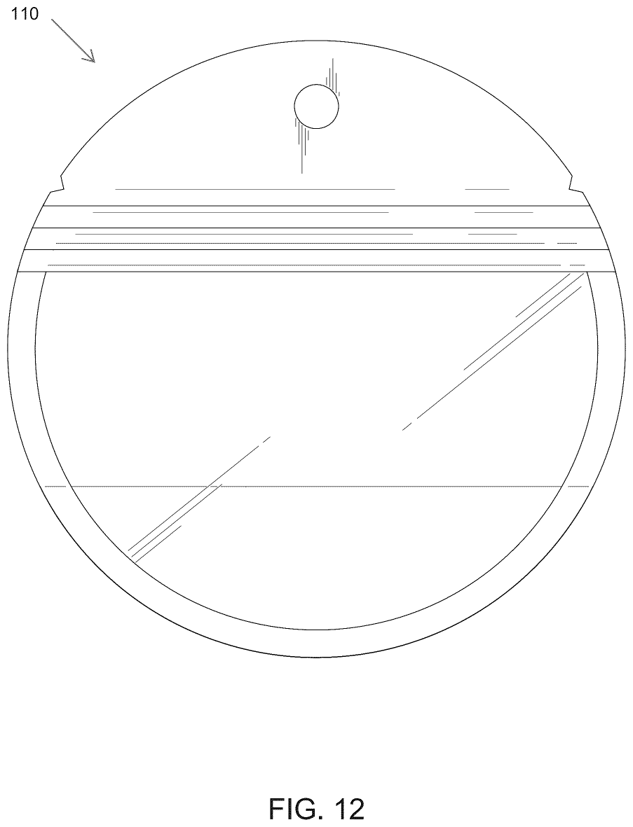

FIG. 13 is a rear elevational view, according to the embodiment of FIGS. 10-12;

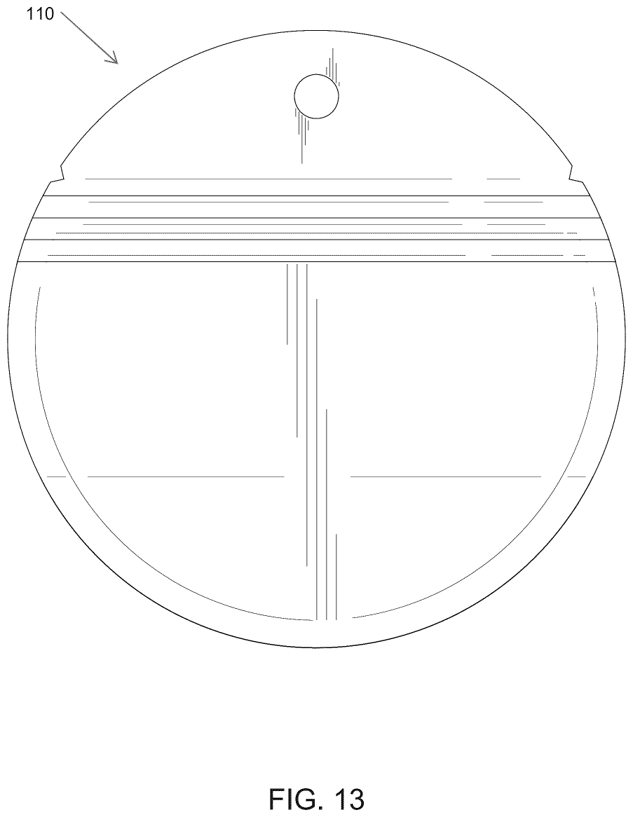

FIG. 14 is a left side elevational view, according to the embodiment of FIGS. 10-13;

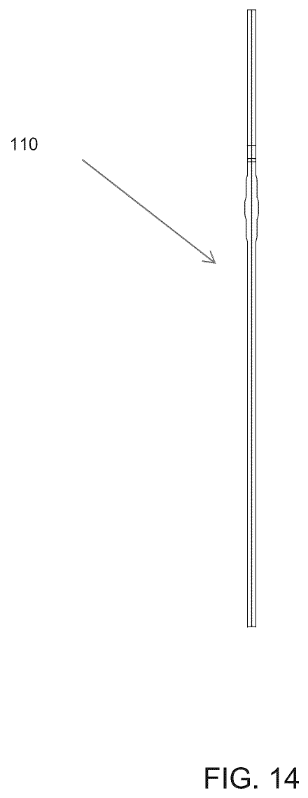

FIG. 15 is a right side elevational view, according to the embodiment of FIGS. 10-14;

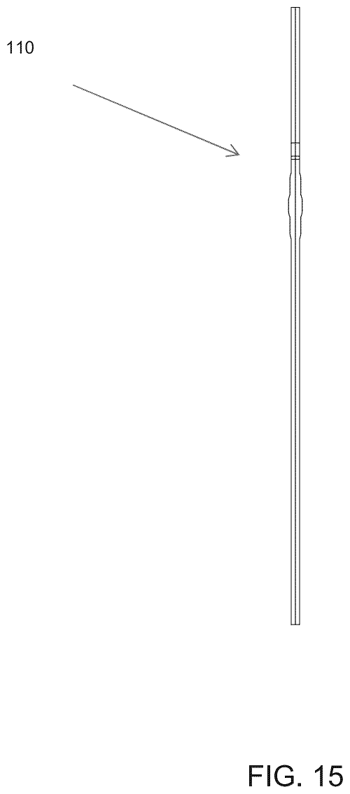

FIG. 16 is a top plan view, according to the embodiment of FIGS. 10-15;

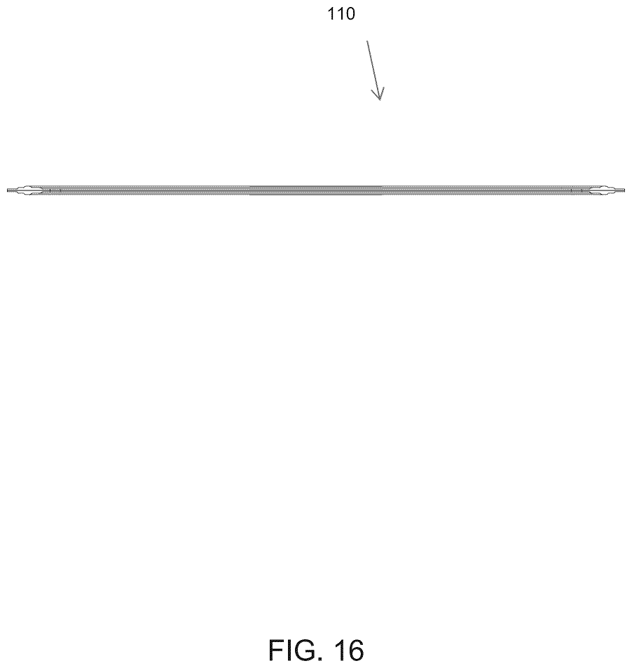

FIG. 17 is a bottom plan view, according to the embodiment of FIGS. 10-16;

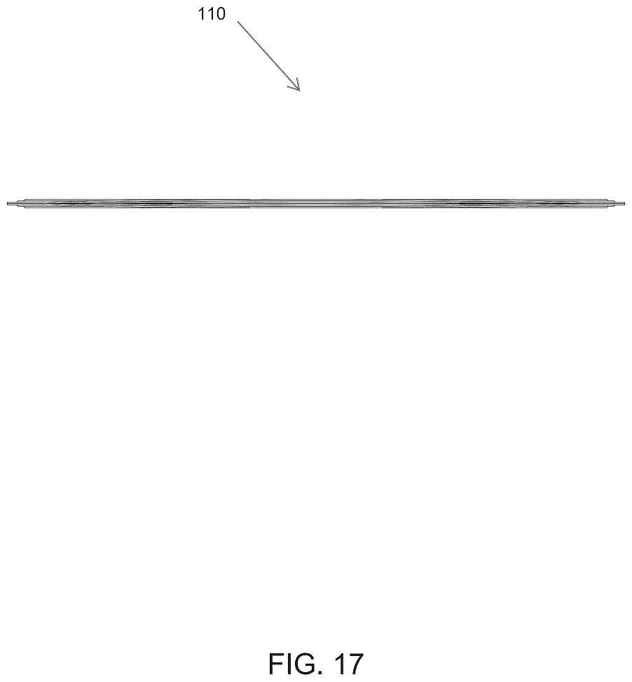

FIG. 18 is an exploded view of a package according to another embodiment; and

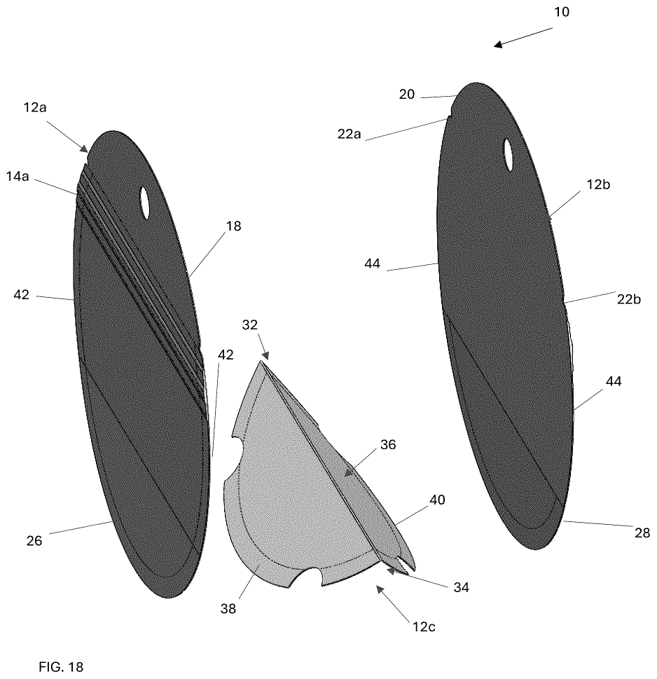

FIG. 19 is an exploded view of a package according tom a further embodiment.

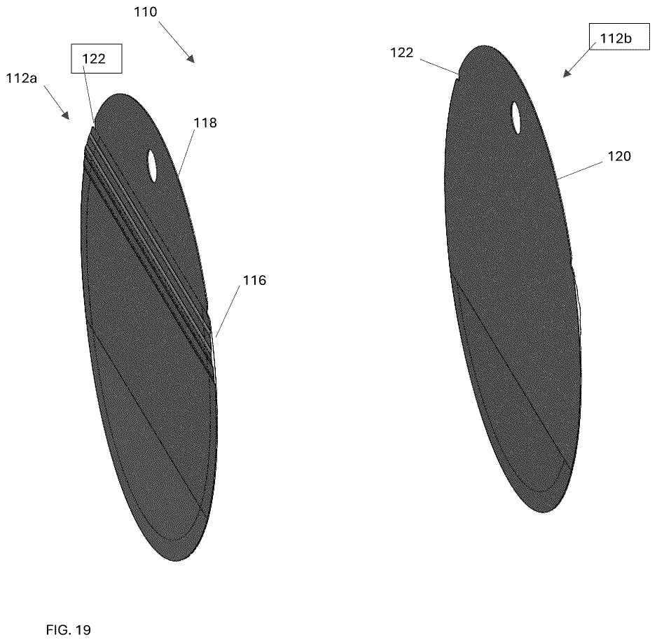

### DETAILED DESCRIPTION

The present disclosure relates to a package, pouch, or container 10 made from one or more sheets 12 of material that are heat sealed together, and the method of making it. The sheets of material are plastic sheets, or sheets of any heat-sealable material, or sheets that are adhered together by adhesive, heat-sealing, or other sealing methods. The sheets 12 can be mesh, non-woven, or other sheets. The sheets can be polyethylene terephthalate (“PET”), or another thermoplastic polymer. The material of the sheets can be PET with a foil material dispersed therein. In embodiments, a first sheet 12a in a round shape is sealed, or at least partially sealed to another second sheet 12b in a round shape, such as by heat-sealing around at least part of the edges of each of the first sheet and second sheet. The round sheets can be cut from a strip of material. In embodiments, the first sheet 12a has a first part 14a of a closure mechanism 16 near an upper end 18 of the first sheet, and the second sheet 12b has a second part 14b of the closure mechanism 16 near an upper end 20 of the second sheet. The first part 14a and second part 14b of the closure mechanism 16 are complementary to each other in that pressing them together forms an openable, reclosable seal. The first part 14a and second part 14b can be made of plastic that is attached to, sealed to, or adhered to, the respective sheet. The closure mechanism 16 may be a zipper, snap, or other structure. A zipper having a slider for pressing the zipper parts together is contemplated. In embodiments, the first 12a and second 12b sheets define a notch 22 at the location of the parts of the closure mechanism (such as, for example, notches 22a and 22b). In embodiments, the upper portion 24 of the package 10 is not sealed together above the closure mechanism.

In embodiments, the first sheet 12a has a lower end 26 and the second sheet 12b has a lower end 28, where the lower end of the first sheet and the lower end of the second sheet are not sealed to one another. In embodiments, the lower ends 26 and 28 are sealed to a third sheet 12c of material forming a gusset for a lower end 30 of the package 10. In embodiments, the third sheet 12c has a first narrow end 32 and a second narrow end 34, and a middle portion 36 that is broader than the first and second narrow ends. In embodiments, the third sheet 12c expands the interior of the package. In embodiments, the third sheet is made from a material that is different from the first sheet and/or second sheet. It can have a different color, different appearance (such as embossing, reflectiveness, etc.). In embodiments, the third sheet has a first edge 38 for being attached to the first sheet and a second edge 40 for being attached to the second sheet.

In embodiments, a method of making a package 10 includes forming a first sheet 12a in a circular or semi-circular shape, forming a second sheet 12b in a circular or semi-circular shape, attaching side portions 42 of the edge of the first sheet to side portions 44 of an edge of the second sheet, leaving a lower portion 26 of the edge of the first sheet unsealed to a lower portion 28 of the edge of the second sheet. In embodiments, an upper portion 18 of the first sheet is not attached to an upper portion 20 of the second sheet. Then, a third sheet 12c is attached to the lower portion 28 of the edge of the first sheet and to the lower portion 30 of the edge of the second sheet. In embodiments, the third sheet 12c forms a gusset. In embodiments, the first sheet 12a has the first part 14a of a closure mechanism 16 and the second sheet 12b has a second part 14b of the closure mechanism 16, and the first sheet 12a is not attached to the second sheet 12b above the location of the closure mechanism.

In embodiments, the first and second sheets are provided with parts of a closure mechanism 16. One or more notches (e.g., 22a and 22b) can be provided at the location of the parts of the closure mechanism. In embodiments, the package 10 includes a tear-away portion 46. The tear-away portion can be at the one or more notches 22 in the side of the package. In embodiments, an interior can be filled with a product before or after the third sheet 12c is attached.

Generally, the package 10 is made from two circular or semi-circular sheets attached to one another at a periphery. The circular or semi-circular sheets are heat sealed together around at least the sides of the package, each sheet carrying one part of a zipper-like closure mechanism 16. The sealing can occur leaving a space unsealed at the bottom and a space unsealed at the top. Then, the gusset (or a third sheet) is attached at the bottom, having one side of the gusset attached to the first sheet and the other side of the gusset attached at the second sheet. The package is then filled, in certain embodiments, through the top of the package. The closure mechanism 16 can be closed after the package is filled.

In embodiments, the sheets are attached using an adhesive. In embodiments, the sheets are attached using welding.

The sealing around the sides of the package can be done first, leaving space for the zipper or other closure features 16. Then, the closure features are attached. In embodiments, the closure features are attached to the first sheet and second sheet. For example, the closure features of the first sheet and second sheet form a zipper-like closure mechanism.

In embodiments, the process is at least partially automated. For example, a series of the circles can be cut out of a long sheet, partially heat sealed together, or attached using adhesive, and then the partially formed package is transferred to a different machine for filling and/or attaching the gusset or third sheet.

In embodiments, the closure mechanism 16 is formed from buttons, snaps, and/or hook and loop fasteners (like Velcro™).

In embodiments, the first sheet 12a, second sheet 12b, and third sheet 12c, or one or more of the sheets, is formed from a polymeric sheet. In embodiments, the first sheet, second sheet, and third sheet, or one or more of the sheets, is formed from a sheet of nonwoven material. In embodiments, the package is made from sheets of paper. In embodiments, one or more of the sheets, or portions thereof, are transparent or translucent. In embodiments, one or more of the sheets, or portions thereof, are reflective and/or embossed. In embodiments, the sheets are attached to each other using heat sealing, welding, adhesives, or the like.

In embodiments, the package 10 is circular and the upper portion 24 thereof is a tear-away portion 46. The package 10 can include one or more notches 22 at the tear-away portion. In embodiments, the tear-away portion 46 is formed by perforations. In embodiments, the package includes a gusset. In embodiments, the gusset is removable. In embodiments, the package 10 is formed from a first circular or semi-circular sheet attached to a second circular or semi-circular sheet, the sheets having a closure mechanism 16. In embodiments, an upper portion 24 of the package above the closure mechanism 16 is not sealed. In embodiments, the upper portion 24 of the package has a tear-away portion 46. In embodiments, the package has a first sheet and a second sheet that are pentagonal, hexagonal, star-shaped, oval, trapezoidal, and are attached to one another using heat sealing, welding, adhesives and the like.

In further embodiments, a method of making a package 110 includes forming a first sheet 112a in a circular or semi-circular shape, forming a second sheet 112b in a circular or semi-circular shape, attaching a portion of the edge of the first sheet 112a to a portion of an edge of the second sheet 112b, leaving an upper portion 118 of the edge of the first sheet 112a unsealed to a upper portion 120 of the edge of the second sheet 112b. In embodiments, the interior of the package is filled. Then, the upper portion can be sealed, or otherwise closed, such as for example, using adhesive or through the closure of a closure mechanism 116. The closure mechanism 116 can be a zipper, press seal, a series of snaps, buttons, a set of hook and loop fasteners, or the like.

In embodiments, the first and second sheets are provided with parts of a closure mechanism 116. One or more notches 122 can be provided at the location of the parts of the closure mechanism. In embodiments, the package 110 includes a tear-away portion 146. The tear-away portion can be at the one or more notches in the side of the package. In embodiments, an interior can be filled with a product before the upper portion of the package is closed.

Generally, the package is made from two circular or semi-circular sheets attached to one another at a periphery. The circular or semi-circular sheets are heat sealed together around at least a portion of the package, each sheet carrying one part of a zipper-like closure mechanism. The sealing can occur leaving a space unsealed at the top. In embodiments, the package is filled before heat sealing or otherwise attaching the unsealed portion of the sheets to each other.

In embodiments, the sheets are attached using an adhesive. In embodiments, the sheets are attached using welding.

In embodiments, the process is at least partially automated. For example, a series of the circles can be cut out of a long sheet, partially heat sealed together, and then the partially formed package is transferred to a different machine for filling and/or closing the package.

In embodiments, the closure mechanism is formed from buttons, snaps, and/or hook and loop fasteners (like Velcro™).

In embodiments, the first sheet 112a, second sheet 112b, or one or more of the sheets, is formed from a polymeric sheet. In embodiments, the first sheet, second sheet, or one or more of the sheets, is formed from a sheet of nonwoven material. In embodiments, the package is made from sheets of paper. In embodiments, one or more of the sheets, or portions thereof, are transparent or translucent. In embodiments, one or more of the sheets, or portions thereof, are reflective and/or embossed. In embodiments, the sheets are attached to each other using heat sealing, welding, adhesives, or the like.

In embodiments, the package is circular and the upper portion thereof is a tear-away portion 146. The package 110 can include one or more notches 122 at the tear-away portion. In embodiments, the tear-away portion is formed by perforations.

In embodiments, the package 110 is formed from a first circular or semi-circular sheet attached to a second circular or semi-circular sheet, the sheets having a closure mechanism 116. In embodiments, the package has a first sheet and a second sheet that are pentagonal, hexagonal, star-shaped, oval, trapezoidal, and are attached to one another using heat sealing, welding, adhesives and the like.

1. A method of making a package, comprising:
providing a first sheet in a circular or semi-circular shape, the first sheet having an upper portion, a lower portion, and side portions;
providing a second sheet in a circular or semi-circular shape, the second sheet having an upper portion, a lower portion, and side portions;
attaching the side portions of the first sheet to the side portions of the second sheet;
attaching a third sheet to the lower portion of the first sheet and attaching the third sheet to the lower portion of the second sheet;
filling an interior of the package with a product; and
closing the package at the upper portion of the first sheet and the upper portion of the second sheet.

2. The method of claim 1, wherein the third sheet has a first side and a second side, wherein the first side is attached to the first sheet and the second side is attached to the second sheet.

3. The method of claim 1, wherein the first sheet has a first portion of a closure mechanism and the second sheet has a second portion of a closure mechanism.

4. The method of claim 1, wherein the package is closed by engaging the first portion of the closure mechanism with the second portion of the closure mechanism.

5. The method of claim 1, wherein the upper portion of the first sheet and the upper portion of the second sheet are not attached to one another.

6. The method of claim 1, wherein the first sheet, second sheet, and third sheet are sheets of a thermoplastic polymer.

7. The method of claim 1, wherein at least one of the first sheet, second sheet, and third sheet are sheets of polymer having a foil included therein.

8. The method of claim 1, wherein at least the third sheet is a sheet of material different from the sheet of material of the first sheet.

9. The method of claim 1, wherein the first sheet, second sheet, and third sheet are attached by heat sealing.

10. The method of claim 1, wherein the closure mechanism is selected from a press seal, a zipper, one or more buttons, an adhesive, and a set of hook and loop fasteners.

11. The method of claim 1, wherein the package is filled with the product from an upper portion of the package.

12. The method of claim 1, wherein the package is filled with the product from a lower portion of the package.

13. A package, comprising:
a first sheet having an upper portion, a lower portion, and side portions;
a second sheet having an upper portion, a lower portion, and side portions, the side portions of the first sheet being attached to the side portions of the second sheet, the first sheet and second sheet being circular in shape;
a first part of a closure mechanism adjacent the upper portion of the first sheet; and
a second part of a closure mechanism adjacent the upper portion of the second sheet, the package being closable by engaging the first part of the closure mechanism with the second part of the closure mechanism, the upper portion of the first sheet being unattached to the upper portion of the second sheet.

14. The package of claim 13, further comprising a third sheet having a first side attached to the first sheet and a second side attached to the second sheet.

15. The package of claim 13, wherein at least the first sheet and second sheet are sheets of thermoplastic polymer.

16. The package of claim 13, wherein at least one of the first sheet and second sheet have a foil material incorporated therein.

17. (canceled)

18. The package of claim 13, wherein the closure mechanism is selected from a group consisting of a zipper, a press seal, a series of buttons, and a set of hook and loop fasteners.

19. The package of claim 13, wherein at least one of the first sheet and the, second sheet has a material that is different from a material of the other of the first sheet and the second sheet.

20. The package of claim 14, wherein the third sheet has a first narrow end, a second narrow end, and a middle portion that is broader than the first narrow end and the second narrow end.
